(19) United States
(12) Patent Application Publication
(10) Pub. No.: US 2020/0057237 A1
(43) Pub. Date: Feb. 20, 2020

(54) LENS MODULE

(71) Applicant: AAC Technologies Pte. Ltd., Singapore City (SG)

(72) Inventor: Chuandong Wei, Shenzhen (CN)

(21) Appl. No.: 16/529,830

(22) Filed: Aug. 2, 2019

(30) Foreign Application Priority Data
Aug. 15, 2018 (CN) 201821313600.3

(51) Int. Cl. G02B 7/02

(52) U.S. Cl. CPC G02B 7/021

(57) ABSTRACT

The present disclosure provides a lens module. The lens module includes: a lens barrel including a first barrel wall having a first inner diameter, a second barrel wall having a second inner diameter and a connecting wall connecting the first barrel wall with the second barrel wall, the first inner diameter being smaller than the second inner diameter; and a set of lenses received in the lens barrel, the set of lenses including a lens surrounded by the second barrel wall. The lens includes a thinned edge portion and a light shading structure sandwiched between the thinned edge portion and the connecting wall. The lens in the lens module provided by the present disclosure reduces stray light, and thus the optical performance is improved. In a case of space limitations, a light shading plate is further provided, so as to adjust gap spacing.

### TECHNICAL FIELD

The present disclosure relates to the technical field of camera lenses, and in particular, to a lens module.

### BACKGROUND

With development of technologies, electronic devices are becoming more and more intelligent. In addition to digital cameras, portable electronic devices such as tablets and mobile phones are also equipped with a lens module. In order to meet the user's requirements, the higher demands have been proposed on imaging quality of the lens module.

In the related art, a light shading sheet of the lens module is sandwiched between two adjacent lenses for providing a light shading effect for the lens. However, the light shading sheet is an annular structure formed by punching into two concentric circles, which has a singular form, and a portion of the light shading sheet abutting against the light shading sheet cannot interfere with the light shading sheet. As a result, the light shading sheet has a poor light shading effect and stray light may even exist, thereby affecting the an optical performance of the lens module.

Therefore, it is necessary to provide a new lens module.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional structural schematic view of a lens module according to an embodiment of the present disclosure;

FIG. 2 is a cross-sectional structural schematic view of a lens barrel according to an embodiment of the present disclosure; and

FIG. 3 is a structural schematic view of a first lens of a lens module according to an embodiment of the present disclosure.

### DESCRIPTION OF EMBODIMENTS

The present disclosure will be further illustrated with reference to the accompanying drawings and the embodiments.

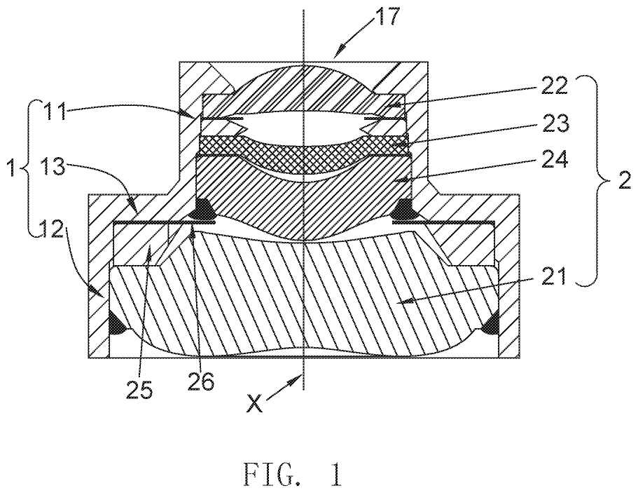

As shown in FIG. 1, an embodiment of the present disclosure provides a lens module including a lens barrel 1 and a set of lenses 2 received in the lens barrel 1.

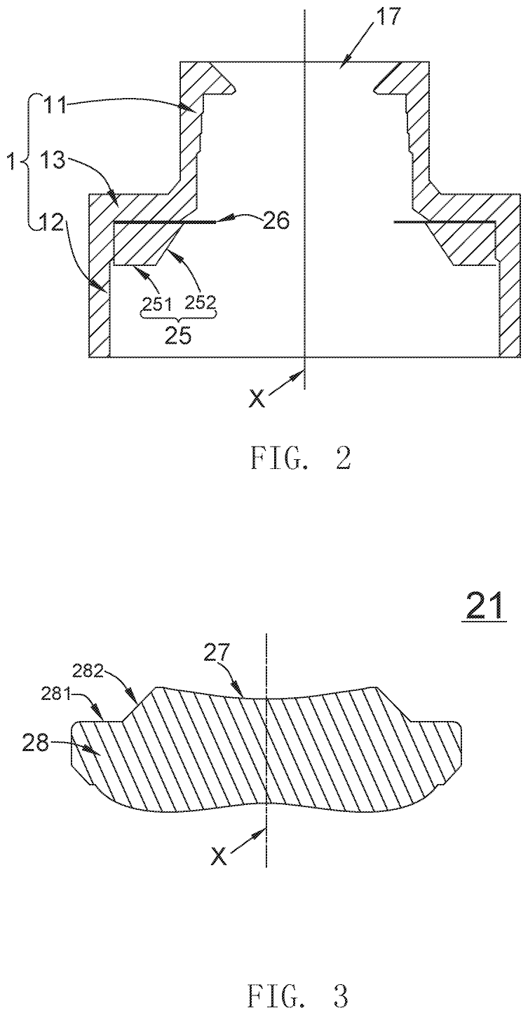

As shown in FIG. 1 and FIG. 2, the lens barrel 1 includes a first barrel wall 11 having a first inner diameter, a second barrel wall 12 having a second inner diameter, and a connecting wall 13 that connects the first barrel wall 11 with the second barrel wall 12. The first inner diameter is smaller than the second inner diameter. The lens barrel 1 further includes a light through hole 17. The lens barrel 1 can be formed into one piece or a fission structure.

As shown in FIG. 3, the set of lenses 2 include a first lens 21 surrounded by the second barrel wall 12. Since the first lens 21 has a symmetrical structure, a left portion of the first lens 21 will be described as an example, and then descriptions of the same structure will be omitted. Specifically, the first lens 21 includes an optical portion 27, and a thinned edge portion 28 surrounding the optical portion 27. A light shading structure is sandwiched between the thinned edge portion 28 and the connecting wall 13, and the light shading structure can improve an optical performance of the lens module.

Specifically, an object-side surface of the edge portion 28 includes a first horizontal surface 281 extending horizontally from an outer edge of the first lens 21 towards an optical axis X, and a light extinction oblique surface 282 extending from the first horizontal surface 281 towards the optical axis X and towards an object side. The light extinction oblique surface 282 can eliminate stray light, for example, by blackening the light extinction oblique surface 282 or coating the light extinction oblique surface 282 with a material for eliminating stray light, etc. In this way, it improves the optical performance of the lens module. Further, in this embodiment, the light shading structure includes a light shading plate 25 and a light shading sheet 26, but is not limited thereto, and may be only a light shading plate 25. The light shading sheet 26 is sandwiched between the connecting wall 13 and the light shading plate 25, and an end of the light shading sheet 26 adjacent to the optical axis X is closer to the optical axis X than an end of the light shading plate 25 close to the optical axis X. The light shading plate 25 and the light shading sheet 26 abut against an inner wall surface of the second barrel wall 12 by means of a right angle. Further, the light shading plate 25 includes a second horizontal surface 251 that is attached to the first horizontal surface 281, and a first oblique surface 252 that extends obliquely from the second horizontal surface 251 towards the optical axis X and towards the object side. The first oblique surface 252 is spaced apart from the light extinction oblique surface 282. In other words, an angle is formed between the first oblique surface 252 and the light extinction oblique surface 282, and the angle is preferably an acute angle.

In addition, the set of lenses 2 further include a second lens 22, a third lens 23 and a fourth lens 24 that are surrounded by the first barrel wall 11, and each lens includes an optical portion and a peripheral portion surrounding the optical portion.

In addition, the first lens 21, the second lens 22, the third lens 23 and the fourth lens 24 are, for example, glass lenses, plastic lenses, or lenses made of other materials. It should be noted that the number of lenses in the set of lenses 2 is not limited to this. Moreover, a light shading plate 25 is arranged between the second lens 22 and the third lens 23, and a light shading sheet is arranged between the third lens 23 and the fourth lens 24. An image side of the peripheral portion of the fourth lens 24 is fixed by adhesive dispensing or by adhesive dispensing after providing a press-ring.

Compared with the related art, for the lens module provided by the present disclosure, the connecting wall of the lens barrel and the peripheral portion of the lens form an enclosing structure, and the light shading structure is arranged in the enclosing structure. Moreover, the lens is further provided with the light extinction oblique surface for reducing stray light, and thus the optical performance is improved. In a case of space limitations, the light shading plate is further provided, so as to adjust gap spacing.

It should be understood by those skilled in the art that the above embodiments are merely some specific embodiments of the present disclosure, and various changes in form and details may be made without departing from the scope of the present disclosure.

What is claimed is:

1. A lens module, comprising:
a lens barrel comprising a first barrel wall having a first inner diameter, a second barrel wall having a second inner diameter and a connecting wall connecting the first barrel wall with the second barrel wall, the first inner diameter being smaller than the second inner diameter; and
a set of lenses received in the lens barrel, the set of lenses comprising a lens surrounded by the second barrel wall,
wherein the lens comprises a thinned edge portion and a light shading structure sandwiched between the thinned edge portion and the connecting wall.

2. The lens module according to claim 1, wherein the thinned edge portion comprises a horizontal surface abutting against the light shading structure, and a light extinction oblique surface connected to the horizontal surface, the light extinction oblique surface extending obliquely from the horizontal surface towards an optical axis and towards an object side.

3. The lens module as described in claim 2, wherein the light extinction oblique surface is spaced apart from the light shading structure.

4. The lens module as described in claim 1, wherein the light shading structure is a light shading plate.

5. The lens module as described in claim 1, wherein the light shading structure comprises a light shading sheet and a light shading plate, the light shading sheet being sandwiched between the connecting wall and the light shading plate.

6. The lens module as described in claim 5, wherein an end of the light shading sheet close to an optical axis is closer to the optical axis than an end of the light shading plate close to the optical axis.

7. The lens module as described in claim 1, wherein the set of lenses further comprises a lens surrounded by the first barrel wall.
